(19) United States
(12) Patent Application Publication
(10) Pub. No.: US 2023/0013744 A1
(43) Pub. Date: Jan. 19, 2023

(54) CONNECTION OF NETWORK MEMBERS

(71) Applicant: WIRELESS DISCOVERY LLC, Los Gatos, CA (US)

(72) Inventor: Ramzi Alharayeri, Los Gatos, CA (US)

(73) Assignee: WIRELESS DISCOVERY LLC, Los Gatos, CA (US)

(21) Appl. No.: 17/947,114

(22) Filed: Sep. 17, 2022

Related U.S. Application Data
(63) Continuation-in-part of application No. 17/061,526, filed on Oct. 1, 2020, now Pat. No. 11,477,604.
Application No. 17/061,526 is a continuation of application No. 16/399,954, filed on Apr. 30, 2019, now Pat. No. 10,834,529.
Application No. 16/399,954 is a continuation of application No. 15/136,842, filed on Apr. 22, 2016, now Pat. No. 10,321,267.
Application No. 15/136,842 is a continuation of application No. 15/000,960, filed on Jan. 19, 2016, now Pat. No. 9,357,352.
Application No. 15/000,960 is a continuation-in-part of application No. 14/570,779, filed on Dec. 15, 2014, now Pat. No. 9,264,875.
Application No. 14/570,779 is a continuation-in-part of application No. 12/351,654, filed on Jan. 9, 2009, now Pat. No. 8,914,024.
(60) Provisional application No. 61/010,891, filed on Jan. 10, 2008.

(51) Int. Cl. G06F 21/31; H04L 67/306; H04L 9/08; H04L 51/58; H04W 12/062

(52) U.S. Cl. CPC G06F 21/31; H04L 67/306; H04L 9/0866; H04L 51/58; H04W 12/062

(57) ABSTRACT

A system includes a database to provide access to stored user profile information about a first user using a respective first mobile communications device and a second user profile, using a respective second mobile communications device. A computing device is to receive a unique member identifier from all communications devices from all users who are members of the network to associate with profiles and authenticate when users sign into a user account; send to the second mobile communications device, an invitation to accept or reject an invitation to connect to the first user including receiving personal attribute information from, or sharing personal attribute information with, the first user; receive, from the second user, an acceptance of the invitation to connect to the first user; and connect the first user and the second user through the computing device for personal communication between first user and the second user.

### CROSS-REFERENCE TO RELATED APPLICATIONS

This application is a continuation-in-part of U.S. application Ser. No. 17/061,526, filed on Oct. 1, 2020, which is a continuation of U.S. application Ser. No. 16/399,954, filed on Apr. 30, 2019, now U.S. Pat. No. 10,834,529, issued Nov. 10, 2020, which is a continuation of U.S. application Ser. No. 15/136,842, filed on Apr. 22, 2016, now U.S. Pat. No. 10,321,267, issued Jun. 11, 2019, which is a continuation of U.S. application Ser. No. 15/000,960, filed on Jan. 19, 2016, now U.S. Pat. No. 9,357,352, issued May 31, 2016, which is a continuation-in-part of U.S. application Ser. No. 14/570,779, filed on Dec. 15, 2014, now U.S. Pat. No. 9,264,875, issued on Feb. 16, 2016, which is a continuation-in-part of U.S. application Ser. No. 12/351,654, filed on Jan. 9, 2009, now U.S. Pat. No. 8,914,024, issued on Dec. 16, 2014, which claims benefit to U.S. Provisional Application No. 61/010,891 filed on Jan. 10, 2008, the complete disclosures of which, in their entireties, are herein incorporated by reference.

### BACKGROUND

### Technical Field

The embodiments herein generally relate to communication systems, and more particularly to user connectivity in a communications network.

### SUMMARY

In view of the foregoing, an embodiment herein provides a system comprising a database to provide, through any of an internet connection and a mobile telecommunications provider network, access to stored user profile information about a first user using a respective first mobile communications device and a second user profile, using a respective second mobile communications device. The system further comprising a computing device to receive a unique member identifier from all communications devices from all users who are members of the network to associate with profiles and authenticate when users sign into a user account; send to the second mobile communications device, an invitation to accept or reject an invitation to connect to the first user including receiving personal attribute information from, or sharing personal attribute information with, the first user; receive, from the second user, an acceptance of the invitation to connect to the first user; and connect the first user and the second user through the computing device for personal communication between first user and the second user, the personal communication comprising one or more SMS, E-mail, chat/instant messaging, multimedia, voice or video, wherein the computing device is configured to locate information about the second user from a network file of the second user, and transmit this information to the first mobile communications device, wherein the first and second users are members of a same network, and wherein the computing device is operable to disclose network attributes of the first and second users for the purpose of connecting members.

The first mobile communications device and the second mobile communications device comprise a communications application that facilitates discovery between members and exchange of information between the first mobile communications device and the second mobile communications device. The computing device is to permit the first mobile communications device to send a SMS message to the second mobile communications device to access a communications application to initiate exchange of information with the first mobile communications device. The computing device is to permit user registration to a communications platform by submitting user credentials from another network or email services, and wherein upon receiving user permission, the computing device is to import contact information of the user from the network or email services.

The computing device is to allow a user to (i) invite contacts imported to the communications platform, (ii) join a communications network, and (iii) connect and use services from the communications network, and wherein the services comprise chat, SMS, and multimedia services. The computing device is to update user location based on information obtained from the first mobile communications device, and wherein the information comprises geolocation information, Global positioning information, or cellular network location, or a combination thereof. The computing device is to allow the first mobile communications device to search members of the network using user identifying information and user location, or a combination thereof, and wherein the computing device is to receive from a network mobile application information of the searched members including information that a member elects to share. The computing device is to recommend members to connect with by sharing member information. The computing device is to associate a profile of the first user as a basis for connection to the second user. The computing device is to allow for searching of users that are within a spatial proximity to each other.

Another embodiment provides a non-transitory machine readable medium storing instructions that, when executed by a computing device, cause the computing device to provide, through any of an internet connection and a mobile telecommunications provider network, access to stored user profile information in a database about a first user using a respective first mobile communications device and a second user profile, using a respective second mobile communications device; receive a unique member identifier from all communications devices from all users who are members of the network to associate with profiles and authenticate when users sign into a user account; send to the second mobile communications device, an invitation to accept or reject an invitation to connect to the first user including receiving personal attribute information from, or sharing personal attribute information with, the first user; receive, from the second user, an acceptance of the invitation to connect to the first user; and connect the first user and the second user through the computing device for personal communication between first user and the second user, the personal communication comprising one or more SMS, E-mail, chat/instant messaging, multimedia, voice or video, wherein the computing device is configured to locate information about the second user from a network file of the second user, and transmit this information to the first mobile communications device, wherein the first and second users are members of a same network, and wherein the computing device is operable to disclose network attributes of the first and second users for the purpose of connecting members.

The first mobile communications device and the second mobile communications device comprise a communications application that facilitates discovery between members and exchange of information between the first mobile communications device and the second communications device. The computing device is to permit the first mobile communications device to send a SMS message to the second mobile communications device to access a communications application to initiate exchange of information with the first mobile communications device. The computing device is to permit user registration to a communications platform by submitting user credentials from another network or email services, and wherein upon receiving user permission, the computing device is to import contact information of the user from the network or email services.

The computing device is to allow a user to (i) invite contacts imported to the communications platform, (ii) join a communications network, and (iii) connect and use services from the communications network, and wherein the services comprise chat, SMS, and multimedia services. The computing device is to update user location based on information obtained from the first mobile communications device, and wherein the information comprises geolocation information, Global positioning information, or cellular network location, or a combination thereof. The computing device is to allow the first mobile communications device to search members of the network using user identifying information and user location, or a combination thereof, and wherein the computing device is to receive from a network mobile application information of the searched members including information that a member elects to share. The computing device is to recommend members to connect with by sharing member information. The computing device is to associate a profile of the first user as a basis for connection to the second user. The computing device is to allow for searching of users that are within a spatial proximity to each other.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a communication platform, according to an embodiment herein;

FIG. 2 illustrates a window-in-window screen used with a communication platform, according to an embodiment herein;

FIG. 3 illustrates a method of creating an online profile and interaction with other databases/networks/emails with window-in-window access to networks, according to an embodiment herein;

FIG. 4 illustrates an architecture overview of a communication platform, according to an embodiment herein;

FIG. 5 illustrates a connection overview of a communication platform, according to an embodiment herein;

FIG. 6 illustrates using a web-based application to manage Electronic Coordinates and interfaces with other outside applications for a communication platform, according to an embodiment herein;

FIG. 7 illustrates bi-directional functionalities between a connection application and an online application, according to an embodiment herein;

FIG. 8 illustrates bi-directional functionalities between two communication devices, such as cell phones, according to an embodiment herein;

FIG. 9 illustrates an example of a communication device being able to identify another communication device using a communication application and initiating information exchange by using a picture and/or name to identify parties, according to an embodiment herein; and

FIG. 10 illustrates an example of a communication device being able to identify another communication device that does not have a communication application and initiating information exchange by using SMS messaging to invite the other communication device to the communication application, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein. As used herein, the terms “a” or “an” are used, as is common in patent documents, include one or more than one. In this document, the term “or” is used to refer to a “nonexclusive or” unless otherwise indicated.

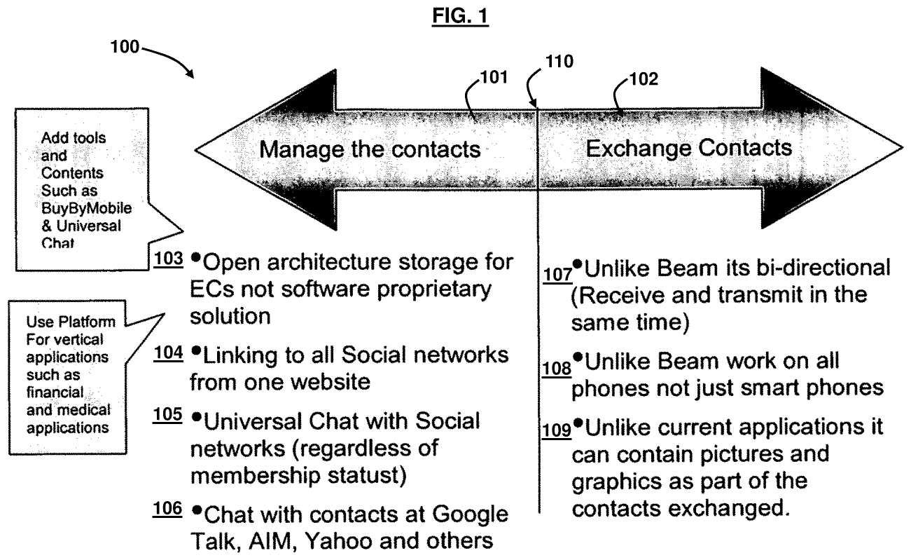

The embodiments herein relate to members discovering other members in the same network who are in the vicinity by personal attributes such as picture(s), name and location. The personal attributes are stored in users' profiles on the network server and are associating with each member's unique member profile and log-in credentials. Discovering other members would be for the purpose of exchanging personal information, connecting to each other through the network services and communicating through SMS, E-mail, chat/instant messaging, text, multimedia, or video features that maybe offered by the same network. Referring now to the drawings, and more particularly to FIGS. 1 through 10, where similar reference characters denote corresponding features consistently throughout the figures, there are shown example embodiments.

The embodiments herein provide a method and system of utilizing a web-based database platform for the exchange of information of the users in a communication network. The platform allows its user(s) to create a customized Electronic Coordinates card (also known as contact information card) that contains a picture or graphics for use with an application (i.e., app) that resides on a cell phone or a hardware device or the like, with short range wireless capabilities, which connect to similar devices in a network to exchange the customized electronic coordinates cards that will be synchronized regularly and stored on a secure web-based application to provide users with the tools to manage their electronic coordinates cards.

As part of managing personal information and a contacts database, the embodiments herein allow a user to bridge between on-line networks memberships (such as, for example, Outlook, Myspace, Facebook. etc.) and contacts within these networks as a unified contact management platform. Specifically, according to the embodiments herein, once a user provides various logging information, the system platform, referred to herein as window-in-window capability, provides the user the convenience of browsing or switching to the network desired by accessing it through a click, touch or drag, depending on the operating system.

Furthermore, the system provided by the embodiments herein copy contacts from within these various networks into a secure database, providing the user with capabilities to chat online universally with all contacts on a single open architecture. In an example, the embodiments herein provide a user with the option of chatting with contacts on the network without having to log in to a third network that both members belong to and furthermore facilitate communication even if one of the two members does not belong to the third network

According to the embodiments herein, a system is provided comprising a first component and a second component. The first component comprises a wireless communication protocol application (for example, a bi-directional communication application).

According to an example, the first component comprises a communication protocol application, such as cellular, which resides on a cell phone or similar portable communication device, such as a laptop, PDA, etc. One aspect of the first components is the functionality to identify other similar applications in the communication network in order to perform the following functions:

Exchange electronic coordinates of the communication devices and/or apps in the network in a digital format and receive electronic coordinates files associated with the communication devices and/or apps. One distinction of such an operation over conventional beaming technology is the bidirectionality of the system provided by the embodiments herein.

The electronic coordinates may include various information such as multiple email addresses, phone numbers and can include pictures as part of the information exchanged. Conventional applications generally do not include pictures or graphics.

In accordance with some examples, during the information exchange process, both communication devices (e.g., phones) receive an electronic message including the other party's picture and/or name, wherein the message asks to accept or deny the information exchange. For example, the message could be a text, pop-up message, any other suitable type of electronic message. The message could also be offered in multiple languages for convenience and localization purposes.

According to various example, the application provided by the first component may reside on any cell phone or the like, and is not limited to smart phone applications, which means that the application could be provided to support to multiple device operating systems. In another example, the application may reside on databank hardware devices that are customized to perform as an exchange device. Furthermore, the application may connect to a web-based open architecture database via cellular network connection or a hardware physical connection for the purpose of storing the user's information and new information obtained as a result of the information exchange between devices. Moreover, the application is capable of including a picture/file link as part of the electronic coordinates, for the purpose of exchanging as a web link pointing to the location of the picture/file. In some examples, the files could include personal data, medical records, or financial information, among other types of data and information.

The system further comprises a second component comprising an online data management application. According to an example, the second component comprises a web-based application that manages a user's profile as well as the contacts that are obtained from the first component (e.g., through the cellular communication protocol) and other contacts that have been manually entered or imported from other contact databases such as personal networks or business networks.

According to some examples, the second component provides for online synchronization through communication networking protocols; e.g., such as cellular, etc., for the purpose of storing electronic coordinates of communication devices in the network and may include pictures or graphics associated with the users of the respective communication devices. Moreover, the second component allows a user to add all contacts from other networks to a master database linked to the second component. Furthermore, the second component may show a user all the networks he/she belong to in a window-in-window format allowing the user the ability to selectively jump from one network to the other by clicking, dragging or pointing to the particular network icon/window. The master database may be communicatively tied to other applications such as a chat tool, among others.

FIG. 1 illustrates an information exchange diagram in accordance with the embodiments herein. The platform 100 provided by the embodiments herein may be a computer or any type of computing device comprising a processor 110 that is configured to manage contacts 101 and exchange contacts 102. Accordingly, the platform 100 is configured to facilitate the management of the contacts 101 of users of communication devices as well as the exchange of contacts 102 among users. In some examples, the management of the contacts 101 utilizes tools and content data components such as BuyByMobile™ and universal chat components 105, 106 to perform some functions. In an example, managing the contacts 101 occurs using an open architecture and/or web storage 103 for electronic coordinates cards (ECs), which is not restricted to software proprietary solutions. According to an example, the platform 100 may be used for various vertical applications such as financial and medical applications. The management of the contacts 101 further links 104 to all computer networks which a user is registered with and does so through one website. In other words, the user information contained in various computer networks are compiled through one website. A universal chat tool 105 is utilized for communication with the various computer networks regardless of the user's membership status (e.g., active, non-active, etc.). Moreover, a chat tool 106 (which may be the same as the chat tool 105 or may be different) provides chatting capabilities with contacts at various networking sites including but not limited, for example, Google Talk™, AIM™, Yahoo!™, among others.

The platform 100 is further configured for facilitating the exchange of contact information 102. Unlike beam technology, the platform 100 uses bi-directional communication 107 in order to receive and transmit contact information simultaneously. Moreover, unlike beam technology, the platform 100 is configured to function 108 on all types of electronic communication devices and phones and not just on smart phones. Furthermore, unlike conventional solutions, the platform 100 may contain pictures and graphics 109 as part of the contact information that is exchanged among users.

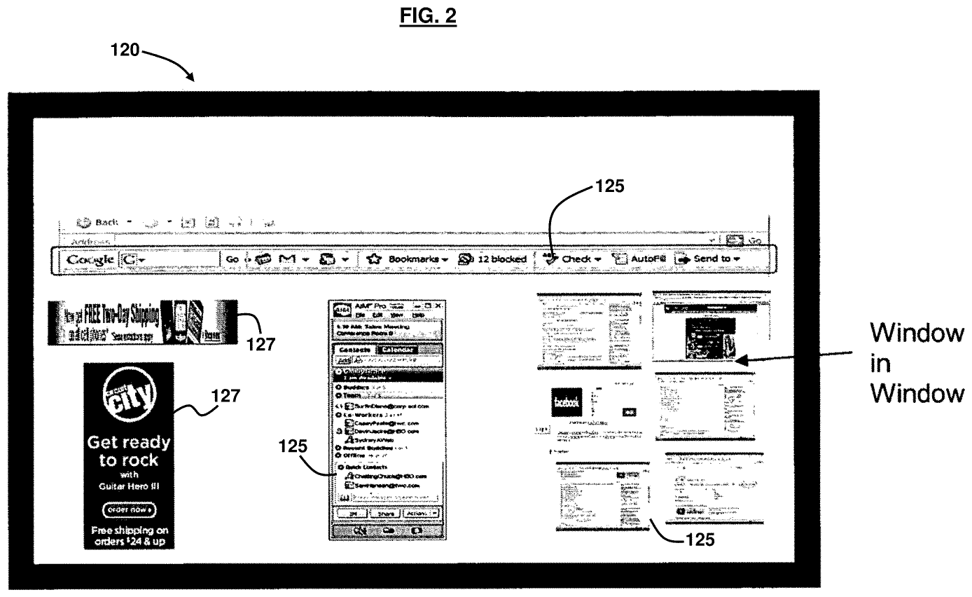

FIG. 2, with reference to FIG. 1, illustrates a window-in-window screen diagram. For example, FIG. 2 may be a screen or viewer 120 that is displayed on a communication device that displays various computer networking screens 125 and other online contents 127 (including web advertisements, etc.) together in one website. This aspect of the embodiments herein may show a user all the networks he/she belong to in a window-in-window format allowing the user the ability to selectively jump from one network to the other by clicking, dragging or pointing to the particular network icon/window.

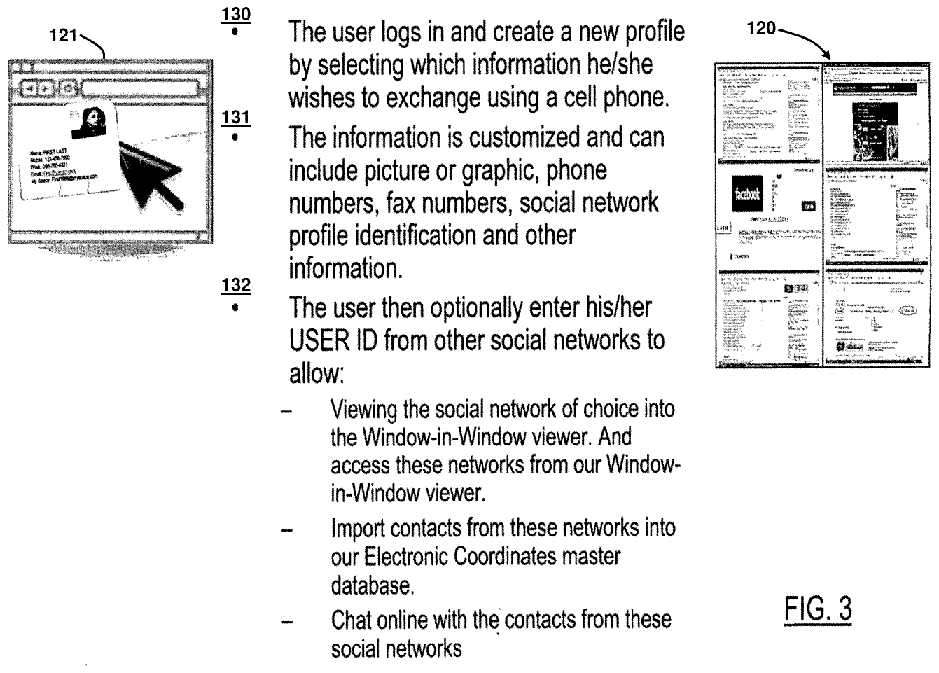

FIG. 3, with reference to FIGS. 1 and 2, illustrates a technique for creating an online profile and interacting with other databases/networks/emails. This may occur using the window-in-window access to computer networks technique as provided in accordance with FIG. 2. As provided in FIG. 3, in item 130, a user logs into a website 121 and creates a new profile by selecting which information he/she wishes to exchange using a communication device, such as a cell phone. In item 131, the information may be customized to a particular user and can include a picture or graphics, phone numbers, fax numbers, network profile identification, and other suitable information. In item 132, a user can optionally enter his/her USER ID from other networks to allow for: (a) viewing the network of choice into the window-in-window viewer 120 and allow for accessing these networks from the window-in-window viewer 120; (b) importing contacts from these networks into an electronic coordinates master database; and (c) chatting online with the contacts from these networks.

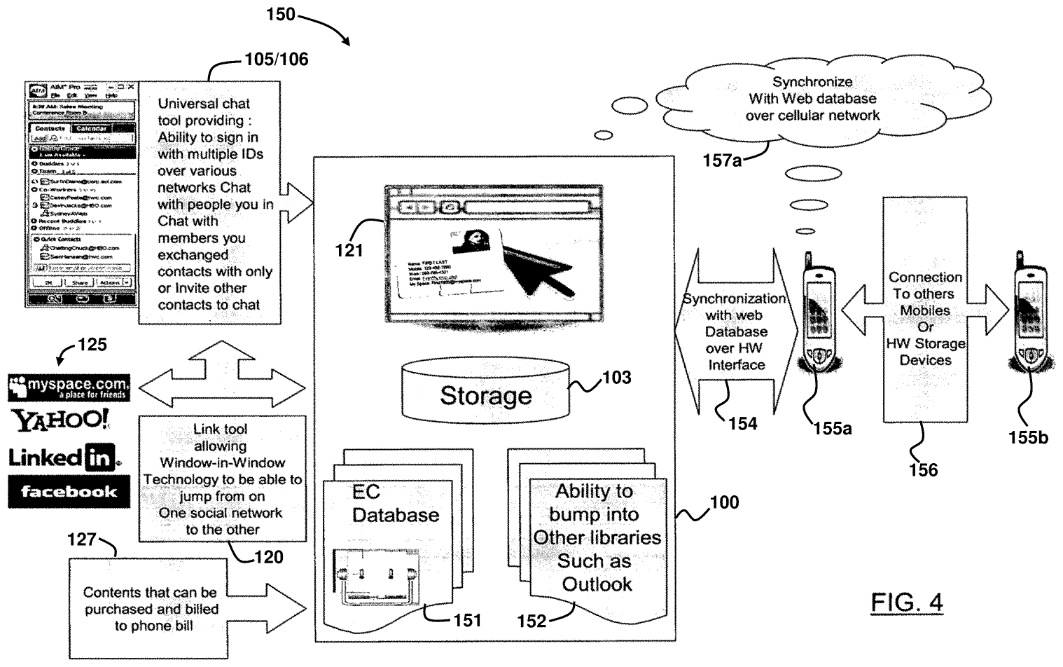

FIG. 4, with reference to FIGS. 1 through 3, illustrates a diagram of the architecture 150 for utilizing the platform 100 in accordance with the embodiments herein. The platform 100 stores the website 121 into which a user logs on to create a new profile, etc. A storage mechanism 103 is provided to store the ECs. In an example, the storage mechanism 103 may be a device or other memory component and may be a web-based storage mechanism. The EC or master database 151 is provided to store the user's contact information from other networks. In accordance with an embodiment herein, the platform 100 may utilize a linking mechanism 152, which provides for the ability to access other online libraries or applications such as Outlook. Contents 127 may be accessed by the platform 100 that can be purchased and billed to a user (e.g., a user's phone bill, etc.).

A universal chat tool 105/106 may be linked to the platform 100 to provide the ability for the user to sign into the website 121 with multiple IDs over various networks and chat with other individuals. Moreover, the chat tool 105/106 allows a user to chat only with other contacts or members with whom the user exchanges contact information or to invite other contacts to chat. The platform 100 is linked (e.g., through a linking tool, etc.) to allow for a window-in-window viewer 120 to be able to jump between screens from one network to another network 125. Additionally, the platform 100 may be configured for synchronization with one or more web databases over an interface (such as a hardware interface) 154 to one or more communication devices 155a, 155b. The one or more communication devices 155a, 155b may be communicatively and wirelessly linked 156 to each other or to others through cellular/mobile networks and may be further connected to hardware storage devices. In the example shown in FIG. 4, communication device 155a may synchronize with a web database over a cellular network 157a, for example.

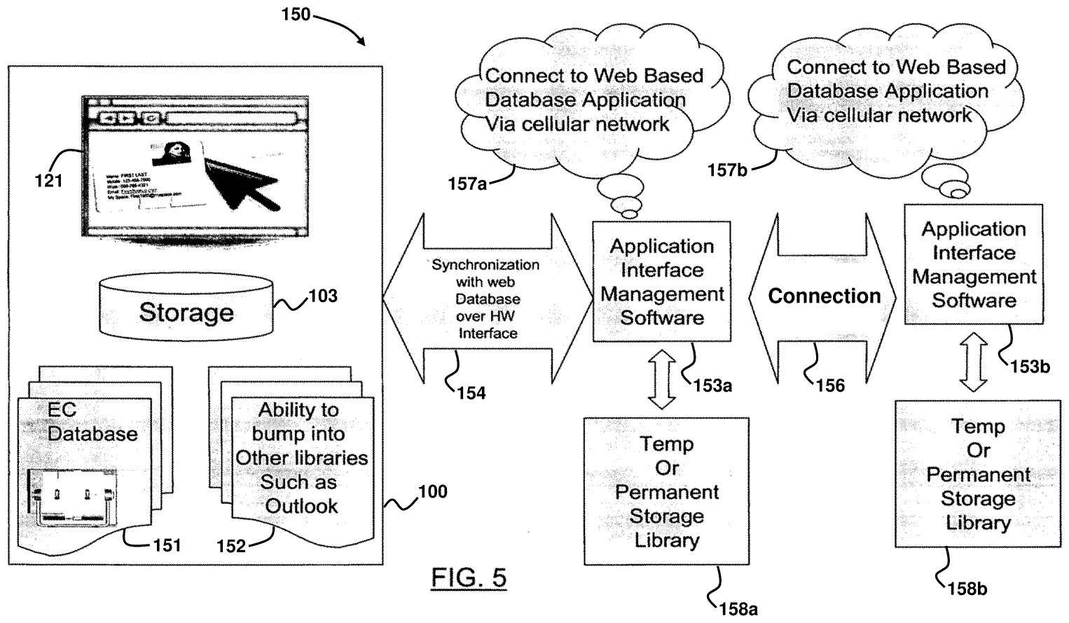

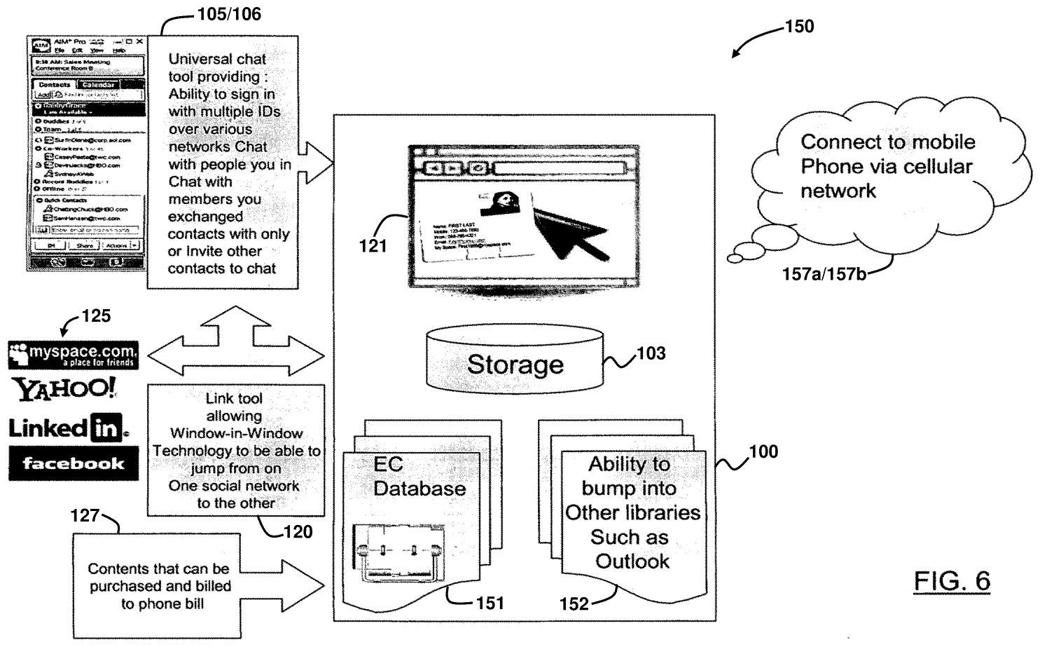

FIG. 5, with reference to FIGS. 1 through 4, further illustrates the architecture 150 for utilizing the platform 100 in accordance with the embodiments herein. As shown in FIG. 5, the communication devices 155a, 155b (of FIG. 4) may respectively run an application interface management software application 153a, 153b that are linked to a temporary or permanent storage library 158a, 158b. The application interface management software application 153a, 153b may assist with the communication protocol links between the communication devices 155a, 155b. In the example shown in FIG. 5, the one or more communication devices 155a, 155b may each synchronize with a web database over a cellular network 157a, 157b, for example. As further shown in FIG. 6, with reference to FIGS. 1 through 5, the web-based application may be used to manage the ECs and interfaces with other outside applications, wherein the platform 100 is configured to communicatively connect to a mobile phone via a cellular network 157a/157b.

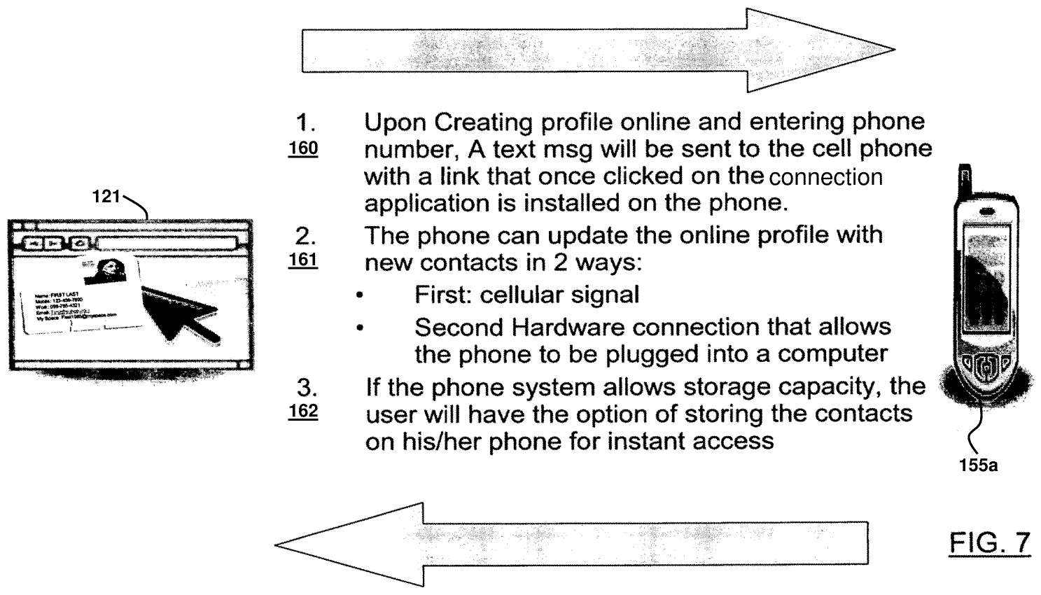

FIG. 7, with reference to FIGS. 1 through 6, illustrate the bi-directional functionalities between a communication device 155a and the online onboarding application (e.g., website 121). First, in item 160, upon creating a profile online website 121 and entering a phone number, a text message is sent to communication device 155a (e.g., a cell phone) with a link that, once clicked on the communication connection, is installed on the communication device 155a. Second, in item 161, the communication device 155a can update the online profile with the new contact(s) in a plurality of ways, such as: (i) cellular signal transmission, or (ii) hardware connection that allows the communication device 155a to be directly connected/plugged to a computer (e.g., the platform 100). Third, in item 162, if the communication device 155a comprises sufficient storage capacity, a user can have the option of storing the contact information of new contacts on the communication device 155a directly for access.

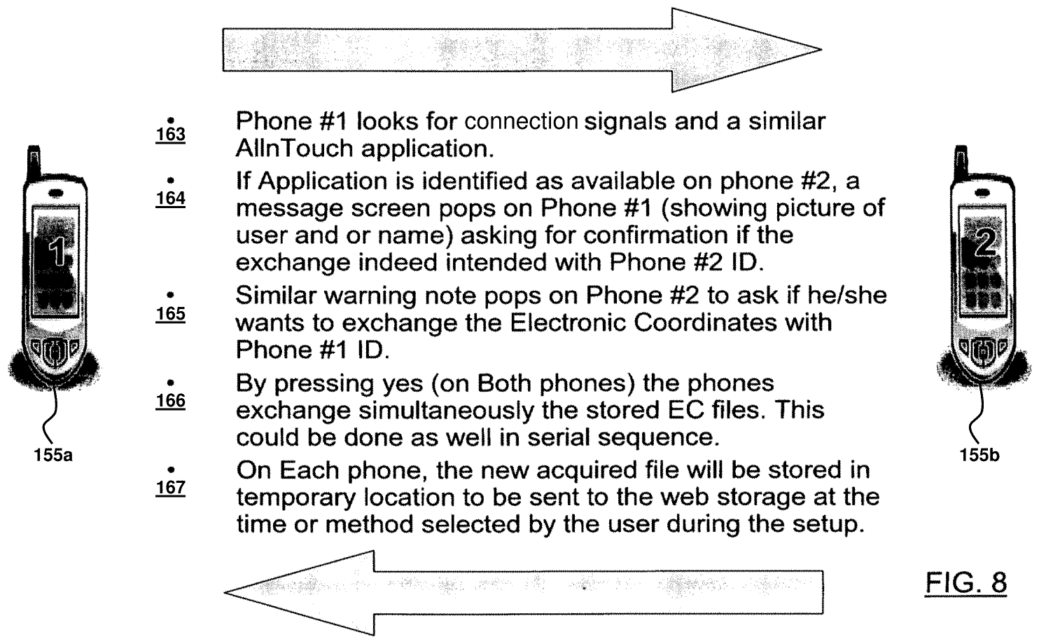

FIG. 8, with reference to FIGS. 1 through 7, illustrate the bi-directional functionalities between a communication device 155a and communication device 155b. In this scenario, in item 163, communication device 155a looks for connection signals and a similar linking application (such as an all Ntouch™ application, for example). In item 164, if an application is identified as available on communication device 155b, a message or screen pops up on the display in communication device 155a showing a picture and/or name of the user of communication device 155b and asks for confirmation if the information exchange is indeed intended with the electronic ID of communication device 155b. In item 165, a similar message pops up on the display on communication device 155b to ask if the user of communication device 155b wants to exchange ECs with the electronic ID of communication device 155a. In item 166, by pressing yes (on both communication device 155a and communication device 155b), the communication devices 155a/155b simultaneously exchange EC files. In another example, alternatively, the exchange of the EC files may happen in a serial sequence. In item 167, on each communication device 155a/155b, the newly acquired EC file will be stored in a temporary storage location to be sent to the web storage 103 at the time or method selected by the user during the initial onboarding setup on website 121.

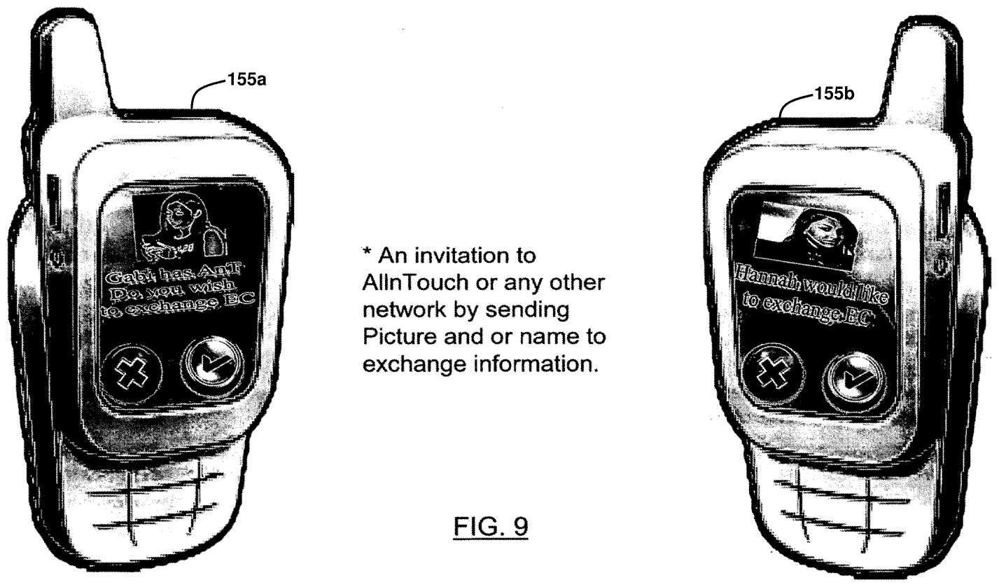

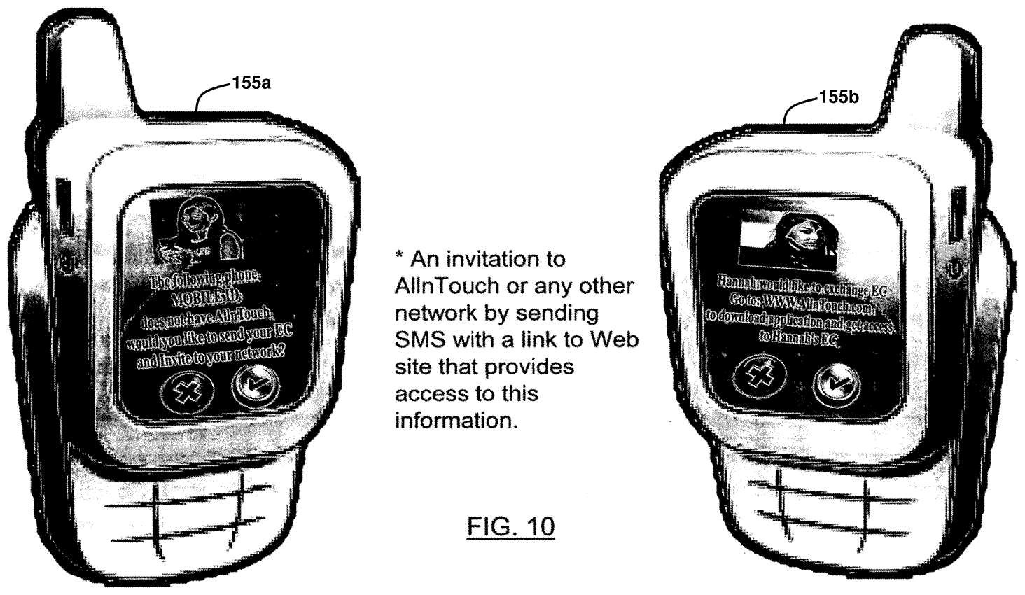

FIGS. 9 and 10, with respect to FIGS. 1 through 8, illustrate interactions between communication device 155a and communication device 155b. For example, as shown in FIG. 9, there may be an invitation to an all Ntouch™ application or any other network by sending a picture and/or name to exchange information. As shown in the example of FIG. 10, there may be an invitation to an all Ntouch™ application or any other network by sending a SMS with a link to a website that provides access to the information to be exchanged. Accordingly, FIG. 9 shows the scenario where the communication devices 155a/155b are able to identify each other with an application such as an all Ntouch™ application and initiates the exchange of information by using a picture and/or name to identify the respective users/parties. Moreover, FIG. 10 shows the scenario where the communications devices 155a/155b are able to identify each other where communication devices 155b does not have an application such as an all Ntouch™ application and instead communication device 155a initiates the information exchange by using SMS messaging to invite communication device 155b to the application such as an all Ntouch™ application or any other network.

According to the embodiments herein, a system 150 is provided comprising a database 151 to provide, through any of an internet connection and a mobile telecommunications provider network 157a, access to stored user profile information about a first user using a respective first mobile communications device 155a and a second user profile, using a respective second mobile communications device 155b. The system 150 further comprising a computing device 100 to receive a unique member identifier from all communications devices from all users who are members of the network to associate with profiles and authenticate when users sign into a user account; send to the second mobile communications device 155b, an invitation to accept or reject an invitation to connect to the first user including receiving personal attribute information from, or sharing personal attribute information with, the first user; receive, from the second user, an acceptance of the invitation to connect to the first user; and connect the first user and the second user through the computing device 100 for personal communication between first user and the second user, the personal communication comprising one or more SMS, E-mail, chat/instant messaging, multimedia, voice or video, wherein the computing device 100 is configured to locate information about the second user from a network file of the second user, and transmit this information to the first mobile communications device 155a, wherein the first and second users are members of a same network, and wherein the computing device 100 is operable to disclose network attributes of the first and second users for the purpose of connecting members.

The first mobile communications device 155a and the second mobile communications device 155b comprise a communications application 153a, 153b that facilitates discovery between members and exchange of information between the first mobile communications device 155a and the second mobile communications device 155b. The computing device 100 is to permit the first mobile communications device 155a to send a SMS message to the second mobile communications device 155b to access a communications application 153a, 153b to initiate exchange of information with the first mobile communications device 155a. The computing device 100 is to permit user registration to a communications platform by submitting user credentials from another network or email services, and wherein upon receiving user permission, the computing device 100 is to import contact information of the user from the network or email services.

The computing device 100 is to allow a user to (i) invite contacts imported to the communications platform, (ii) join a communications network, and (iii) connect and use services from the communications network, and wherein the services comprise chat, SMS, and multimedia services. The computing device 100 is to update user location based on information obtained from the first mobile communications device 155a, and wherein the information comprises geolocation information, Global positioning information, or cellular network location, or a combination thereof. The computing device 100 is to allow the first mobile communications device 155a to search members of the network using user identifying information and user location, or a combination thereof, and wherein the computing device 100 is to receive from a network mobile application information of the searched members including information that a member elects to share. The computing device 100 is to recommend members to connect with by sharing member information. The computing device 100 is to associate a profile of the first user as a basis for connection to the second user. The computing device 100 is to allow for searching of users that are within a spatial proximity to each other.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

What is claimed is:

1. A system comprising:
a database to:
provide, through any of an internet connection and a mobile telecommunications provider network, access to stored user profile information about a first user using a respective first mobile communications device and a second user profile, using a respective second mobile communications device; and
a computing device to:
receive a unique member identifier from all communications devices from all users who are members of the network to associate with profiles and authenticate when users sign into a user account;
send to the second mobile communications device, an invitation to accept or reject an invitation to connect to the first user including receiving personal attribute information from, or sharing personal attribute information with, the first user;
receive, from the second user, an acceptance of the invitation to connect to the first user; and
connect the first user and the second user through the computing device for personal communication between first user and the second user, the personal communication comprising one or more SMS, E-mail, chat/instant messaging, multimedia, voice or video,
wherein the computing device is configured to locate information about the second user from a network file of the second user, and transmit this information to the first mobile communications device,
wherein the first and second users are members of a same network, and
wherein the computing device is operable to disclose network attributes of the first and second users for the purpose of connecting members.

2. The system of claim 1, wherein the first mobile communications device and the second mobile communications device comprise a communications application that facilitates discovery between members and exchange of information between the first mobile communications device and the second mobile communications device.

3. The system of claim 1, wherein the computing device is to permit the first mobile communications device to send a SMS message to the second mobile communications device to access a communications application to initiate exchange of information with the first mobile communications device.

4. The system of claim 1, wherein the computing device is to permit user registration to a communications platform by submitting user credentials from another network or email services, and wherein upon receiving user permission, the computing device is to import contact information of the user from the network or email services.

5. The system of claim 4, wherein the computing device is to allow a user to (i) invite contacts imported to the communications platform, (ii) join a communications network, and (iii) connect and use services from the communications network, and wherein the services comprise chat, SMS, and multimedia services.

6. The system of claim 1, wherein the computing device is to update user location based on information obtained from the first mobile communications device, and wherein the information comprises geolocation information, Global positioning information, or cellular network location, or a combination thereof.

7. The system of claim 1, wherein the computing device is to allow the first mobile communications device to search members of the network using user identifying information and user location, or a combination thereof, and wherein the computing device is to receive from a network mobile application information of the searched members including information that a member elects to share.

8. The system of claim 1, wherein the computing device is to recommend members to connect with by sharing member information.

9. The system of claim 1, wherein the computing device is to associate a profile of the first user as a basis for connection to the second user.

10. The system of claim 1, wherein the computing device is to allow for searching of users that are within a spatial proximity to each other.

11. A non-transitory machine readable medium storing instructions that, when executed by a computing device, cause the computing device to:
provide, through any of an internet connection and a mobile telecommunications provider network, access to stored user profile information in a database about a first user using a respective first mobile communications device and a second user profile, using a respective second mobile communications device;
receive a unique member identifier from all communications devices from all users who are members of the network to associate with profiles and authenticate when users sign into a user account;
send to the second mobile communications device, an invitation to accept or reject an invitation to connect to the first user including receiving personal attribute information from, or sharing personal attribute information with, the first user;
receive, from the second user, an acceptance of the invitation to connect to the first user; and
connect the first user and the second user through the computing device for personal communication between first user and the second user, the personal communication comprising one or more SMS, E-mail, chat/instant messaging, multimedia, voice or video,
wherein the computing device is configured to locate information about the second user from a network file of the second user, and transmit this information to the first mobile communications device,
wherein the first and second users are members of a same network, and
wherein the computing device is operable to disclose network attributes of the first and second users for the purpose of connecting members.

12. The non-transitory machine readable medium of claim 11, wherein the first mobile communications device and the second mobile communications device comprise a communications application that facilitates discovery between members and exchange of information between the first mobile communications device and the second communications device.

13. The non-transitory machine readable medium of claim 11, wherein the computing device is to permit the first mobile communications device to send a SMS message to the second mobile communications device to access a communications application to initiate exchange of information with the first mobile communications device.

14. The non-transitory machine readable medium of claim 11, wherein the computing device is to permit user registration to a communications platform by submitting user credentials from another network or email services, and wherein upon receiving user permission, the computing device is to import contact information of the user from the network or email services.

15. The non-transitory machine readable medium of claim 14, wherein the computing device is to allow a user to (i) invite contacts imported to the communications platform, (ii) join a communications network, and (iii) connect and use services from the communications network, and wherein the services comprise chat, SMS, and multimedia services.

16. The non-transitory machine readable medium of claim 11, wherein the computing device is to update user location based on information obtained from the first mobile communications device, and wherein the information comprises geolocation information, Global positioning information, or cellular network location, or a combination thereof.

17. The non-transitory machine readable medium of claim 11, wherein the computing device is to allow the first mobile communications device to search members of the network using user identifying information and user location, or a combination thereof, and wherein the computing device is to receive from a network mobile application information of the searched members including information that a member elects to share.

18. The non-transitory machine readable medium of claim 11, wherein the computing device is to recommend members to connect with by sharing member information.

19. The non-transitory machine readable medium of claim 11, wherein the computing device is to associate a profile of the first user as a basis for connection to the second user.

20. The non-transitory machine readable medium of claim 11, wherein the computing device is to allow for searching of users that are within a spatial proximity to each other.
